(19) United States
(12) Patent Application Publication
(10) Pub. No.: US 2004/0268022 A1
(43) Pub. Date: Dec. 30, 2004

(54) Method for expediting reading and writing on a non-volatile storage medium

(76) Inventor: Sheng-Zhong Shieh, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/603,920

(22) Filed: Jun. 26, 2003

(51) Int. Cl. G06F 12/00

(52) U.S. Cl. 711/103; 711/170

(57) ABSTRACT

The invention provides a method for expediting reading and writing on a non-volatile storage medium. The method is to adjust the size, location, and allocation unit (cluster) of each system parameter block of a non-volatile storage medium according to the storage medium's capacity and block size at the time when system planning/formatting is performed. Then, after system planning/formatting, the non-volatile storage medium is able to write in data starting from the initial position of one of the blocks of the non-volatile storage medium whenever the host end is storing the file data. Thus, the invention can reduce data movement and enhance system performance effectively.

### BACKGROUND OF THE INVENTION

1. Field of the Invention

The invention relates to a method for expediting reading and writing on a non-volatile storage medium and, more particularly, to a method for adjusting the size, location, and allocation unit (i.e. a cluster) of a system parameter block of a non-volatile storage medium so that the storage medium is able to write in data from the initial position of a block each time when the storage medium stores data and thus reduce data movement.

2. Description of the Related Art

Benefiting from the prevalence of computer information products and being able to write and erase data like a non-volatile memory, the flash memory has been broadly employed in small-sized and easy-to-be-carried electronic products, such as notebook computers and digital cameras.

A block comprising a plurality of bytes is a unit used by a non-volatile storage medium for storing and reading data. Currently, a block is usually segmented into 16 or 32 pages, and each page has a plurality of bytes, normally at 512 bytes. FIG. 1 is a schematic diagram showing that data is stored in a non-volatile storage medium 10 according to the prior art. Referring to FIG. 1, a non-volatile storage medium 10 is segmented into a plurality of blocks 12. When data is written into the non-volatile storage medium 10, it is not certain whether the data will be written on the page starting from the first page of the blocks 12. For this reason, data from different files is often stored across blocks. For instance, as shown in FIG. 1, each file of the files A, B, & C is occupying two of the blocks 12 respectively. Therefore, when the host end is going to update the file B into file B′, the blocks 12 occupied by data cannot be overwritten directly because non-volatile storage medium 10 has its limitation. Instead, the host end must first find an empty block 14, as shown in FIG. 2(a), and write data in the front section of the updated file B′ into the empty block 14. Then, as shown in FIG. 2(b), the data in the file A of the original block will be moved to the new block 14. After that, another empty block 16 has to be found, and data in the rear section of the updated file B′ will be written into the block 16, as what is shown in FIG. 2(C). Next, referring to FIG. 2(d), data in the file C of the original block will be moved to the new block 16. Finally, after the data movement has been done, the two blocks that were originally occupied by the file B will be erased and become empty blocks again. However, such conventional method for data movement requires a plurality of new empty blocks to be found every time before updating data. Then, in addition to writing the updated file B′ into an empty block, data in the file A and file C, which is at the same block as data in the front and rear sections of the file B, has to be removed to a new empty block. Therefore, the time spending on writing in data will become longer. Besides, since the file B is stored across two blocks, it has to give a reading-out command twice when reading data because the nature of non-volatile storage medium 10 requires doing so. For this reason, the speed of accessing data of memory will be slow down.

Therefore, focusing on the aforementioned problem, the invention provides a method for expediting reading and writing on a non-volatile storage medium to solve the problem caused by the prior art.

### SUMMARY OF THE INVENTION

The object of the invention is to provide a method for expediting reading and writing on a non-volatile storage medium. Through adjusting the size, location, and allocation unit (cluster) of a system parameter block of a non-volatile storage medium at system planning/formatting, the non-volatile storage medium is able to write in data from the initial position of a block whenever the host end is storing the file data and thus reduce data movement as well as read and write on the non-volatile memory rapidly. Hence, system performance can be enhanced effectively.

According to the invention, a method for expediting reading and writing on a non-volatile storage medium includes the following procedures. First, at system planning/formatting, the size, location, and allocation unit (cluster) of a system parameter block of a non-volatile storage medium will be adjusted. Next, each time when a host end is storing data into the blocks of non-volatile storage medium, the data will be written onto the non-volatile storage medium starting from the initial position of one of the blocks. In particular, the method for adjusting the size, location, and allocation unit (cluster) of a system parameter block includes the following steps. First, the host end gives command to the non-volatile storage medium for inquiring capacity and block size of the storage medium. Second, the size, location, and allocation unit (cluster) of each system parameter block will be calculated according to the capacity and block size of the non-volatile storage medium. Third, the parameters of the system parameter blocks will be corrected according to the calculated values of the size, location, and allocation unit (cluster) of the system parameter blocks. Fourth, the host end will give a command for writing data from the system parameter blocks to the non-volatile storage medium so as to complete the system planning/formatting. By doing so, each data writing that follows afterwards will start from the initial position of one of the blocks.

The objects and technical contents of the invention will be better understood through the description of the following embodiments with reference to the drawings.

### BRIEF DESCRIPTION OF THE DRAWINGS

FIG. 1 is a schematic diagram showing that data is stored in a non-volatile storage medium according to the prior art.

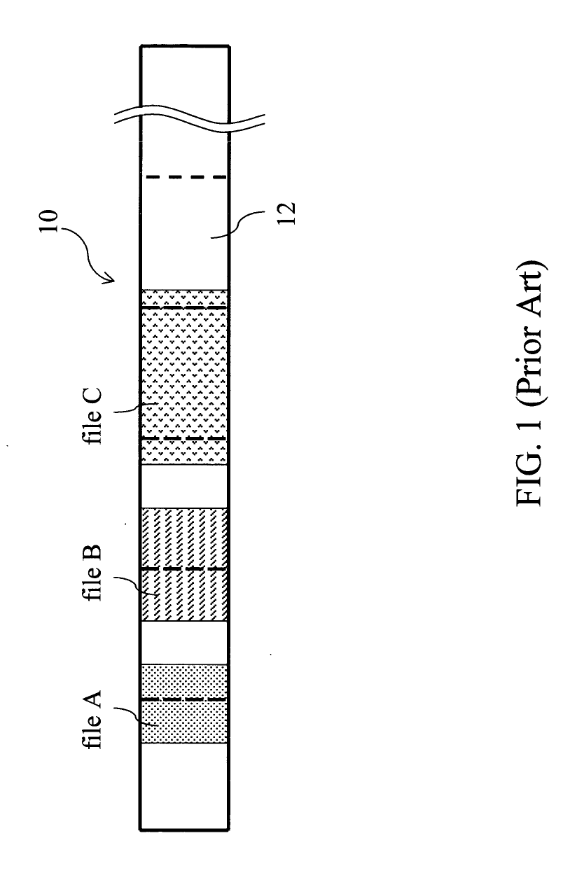

FIGS. 2(a)˜2(d) are schematic diagrams showing that consecutive actions of data movement are done for updating a file data according to the prior art.

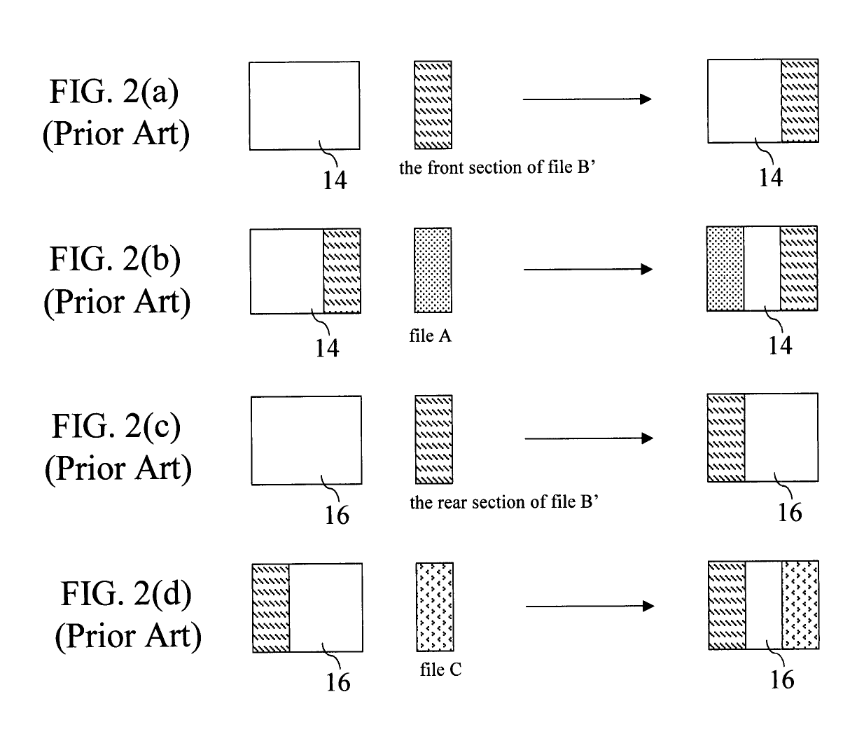

FIG. 3 is a schematic diagram showing relationship between blocks and pages of the non-volatile storage medium of the invention.

FIG. 4 is a schematic diagram showing each system parameter block of the non-volatile storage medium of the invention.

FIG. 5 is a schematic diagram showing that the non-volatile storage medium of the invention is connected to a host end.

FIG. 6 is a schematic diagram showing that data of the invention is stored in the non-volatile storage medium after parameter adjustment.

FIG. 7 is a schematic diagram showing that data movement is done due to updating a file data of the invention.

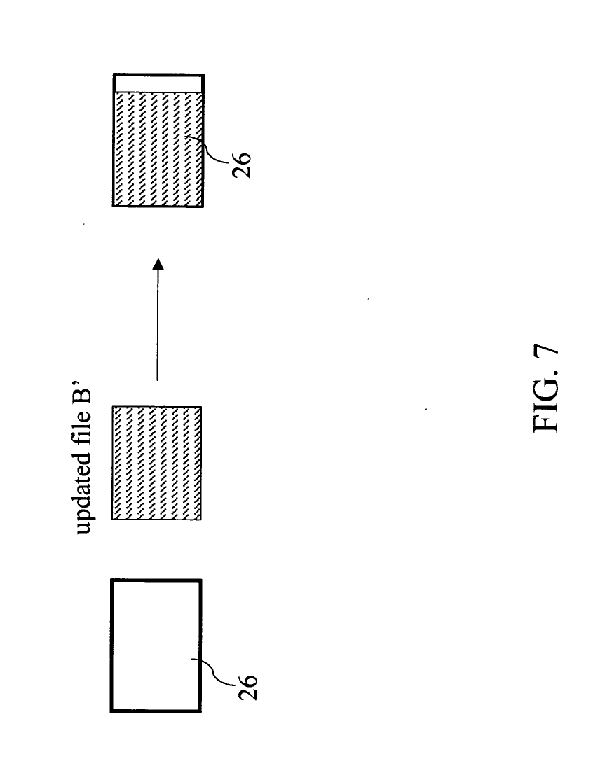

### DETAILED DESCRIPTION OF THE PREFERRED EMBODIMENTS

The invention is to adjust the size, location, and allocation unit of a system parameter block of a non-volatile storage medium at system planning/formatting so that data can be written in starting from the initial position of one of the blocks of the non-volatile storage medium each time when the host end is storing data into the non-volatile storage medium so as to reduce data movement.

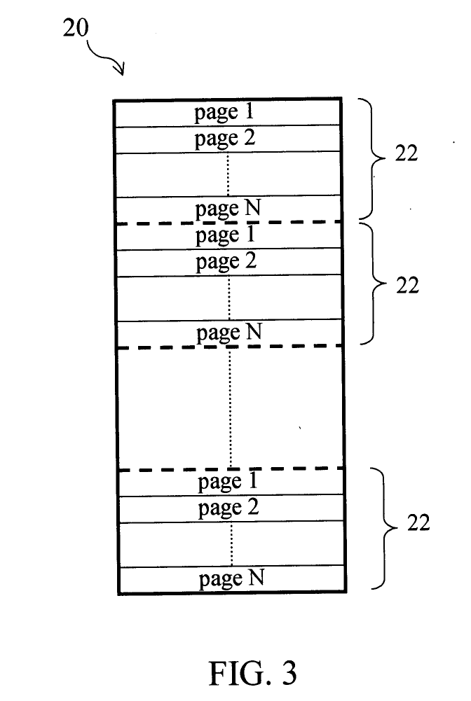

Referring to FIG. 3, a non-volatile storage medium 20 is defined to be a plurality of blocks 22, and the blocks 22 are used as a unit for data storage and reading; meanwhile, the blocks 22 are also used as a unit for erasing data. Besides, each block of the blocks 22 available for data accessing is composed of 16 or 32 pages, wherein each page has a plurality of bytes, usually at 512 bytes. The non-volatile storage medium 20 is often used in flash memory.

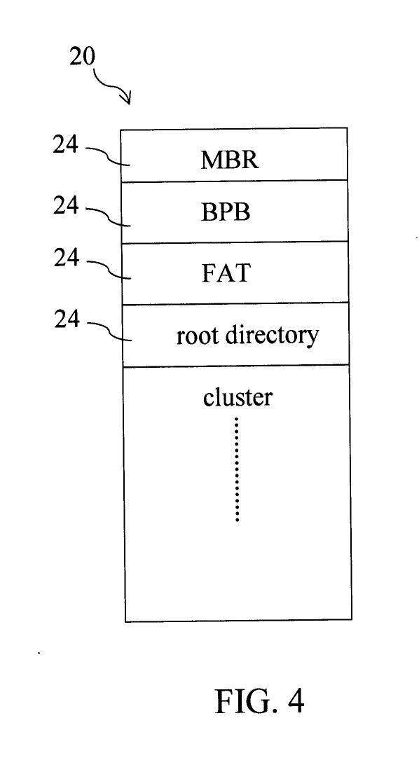

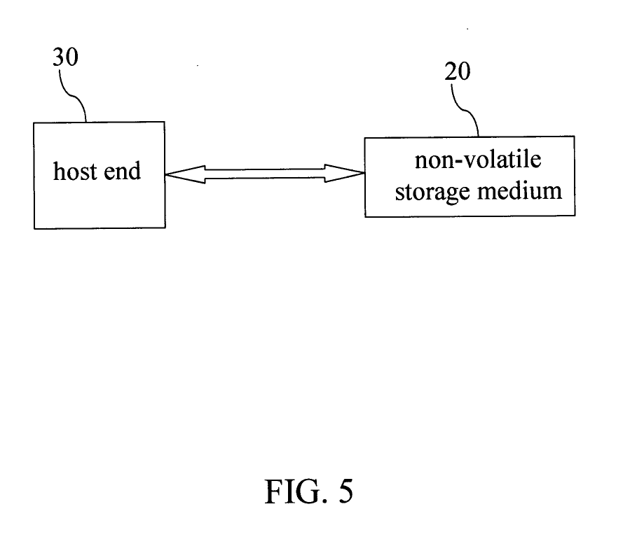

Also, referring to FIG. 4, the file system of the non-volatile storage medium 20 usually comprises a plurality of system parameter blocks 24, which include master boot record (MBR), basic input/output system (BIOS) parameter block (BPB), file allocation table (FAT), and root directory, wherein each system parameter block 24 has its own size and own position in the non-volatile storage medium 20. In general, before a brand-new storage medium is installed into a host system for data storage, the new storage medium has to be done with system planning (FDISK) and formatting first. Therefore, to meet such rule, the non-volatile storage medium 20 of the invention has to adjust the size, location, and allocation unit (also referred as a cluster, which is the smallest unit of a file) of each system parameter block in its file system at its first-time application or at system re-planning/reformatting, so that the initial position of each file can be at the initial position of the blocks 22. In addition, the method for adjusting the size, location, and allocation unit of each system parameter block 24 usually applies labor manipulation, including the following steps. First, referring to FIG. 5 and the aforementioned structure, at system planning/formatting and at the time when the non-volatile storage medium 20 is installed on a host end 30, the host end 30 gives command to inquire the capacity and size of blocks 22 of the non-volatile storage medium 20. Second, the size, position, and unit allocation of each system parameter block 24 will be calculated according to the capacity and size of the blocks 22. Third, the calculated values of size, position, and allocation unit of each system parameter block 24 will be used for correcting the parameters of MBR and BPB by the host end 30. Fourth, when the host end 30 gives a write-data command, the data from the system parameter blocks 24, including MBR, BPB, FAT, and root directory, will be written into the non-volatile storage medium 20 respectively to complete system planning/formatting. Therefore, when the non-volatile storage medium 20 is to be used afterwards, the data to be written in will start from the initial position of one of the blocks 22.

The preferred embodiment of the aforementioned method for adjusting the size, position, and allocation unit of the system parameter blocks 24 is using software, which usually is an application program (AP) or software tool.

The aforementioned software usually is to be built in the host end 30. Besides, in the method for adjusting the system parameter blocks of the invention, a controller can be connected between the non-volatile storage medium 20 and the host end 30. By using the controller as a signal transmission medium, not only can the software be built in the host end 30, but the user can also build the software in the controller, so that an operation can be done through the host end 30 or through the software on the controller.

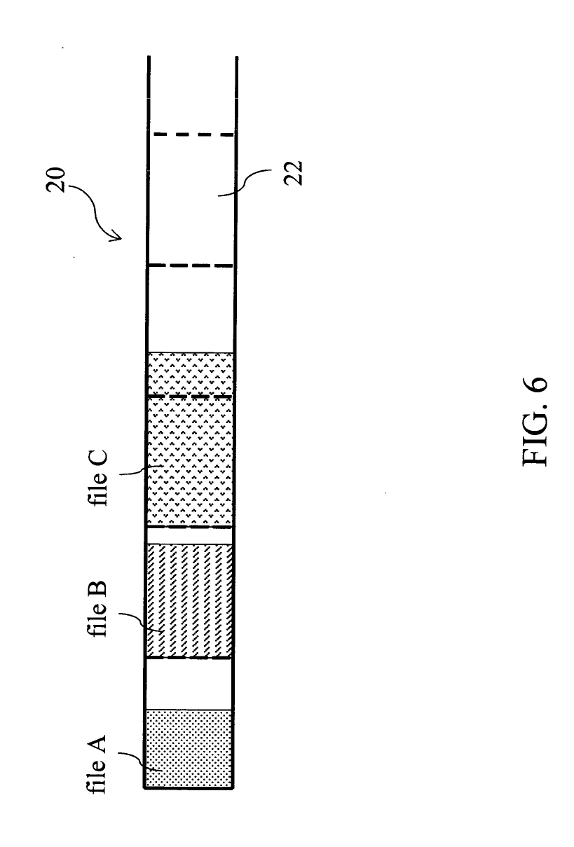

Therefore, by means of the software and method of the invention, the size, position, and allocation unit of each system parameter block 24 of the non-volatile storage medium 20 can be adjusted. After that, the data being stored in the non-volatile storage medium 20 done by the host end 30 is shown in FIG. 6, in which the initial position of each file is located at the initial position of one of the blocks 22. Thus, when the host end 30 is reading one of the files such as file B, the command for reading file B only has to be given out once by the host end 30 because the file B is stored within the same block. And if the host end 30 intends to update the file B into file B′, the only thing needed to be done is to find an empty block 26 in the non-volatile storage medium 20 so that the file B′ can be written into the empty block 26. In addition, the data will be written in starting from the initial position of the block 26 without moving data in the file A and file C like the prior art did; therefore, data movement can be reduced. Hence, the invention can speed up reading and writing on the non-volatile storage medium so as to enhance the performance of the system.

The embodiment above is only intended to illustrate the invention; it does not, however, to limit the invention to the specific embodiment. Accordingly, various modifications and changes may be made without departing from the spirit and scope of the invention as described in the appended claims.

What is claimed is:

1. A method for expediting reading and writing on a non-volatile storage medium, including the following steps:
adjusting the size, location, and allocation unit (cluster) of each system parameter block in the file system of a non-volatile storage medium at system planning/formatting; and
writing in data starting from the initial position of one of the blocks of the non-volatile storage medium each time when the host end is storing data into the non-volatile storage medium.

2. The method for expediting reading and writing on a non-volatile storage medium as claimed in claim 1, wherein the size, location, and allocation unit (cluster) of files in the system parameter blocks are adjusted through software.

3. The method for expediting reading and writing on a non-volatile storage medium as claimed in claim 1, wherein the method for adjusting the size, location, and allocation unit (cluster) of each system parameter block includes the following steps:
first, the host end gives command to the non-volatile storage medium for the capacity and block size of the storage medium, and then the size, location, and allocation unit (cluster) of each system parameter block will be calculated according to the capacity and block size of the non-volatile storage medium;
second, the parameters of the system parameter blocks will be corrected according to the calculated values of the size, location, and allocation unit (cluster) of each system parameter block; and
third, the host end will give a command for writing data from the system parameter blocks to the non-volatile storage medium so as to complete the system planning/formatting, and by doing so, each data writing that follows afterwards will start from the initial position of one of the blocks.

4. The method for expediting reading and writing on a non-volatile storage medium as claimed in claim 3, wherein the step of inquiry made from the host end to the non-volatile storage medium about the capacity and block size of the non-volatile storage medium is carried out by commands.

5. The method for expediting reading and writing on a non-volatile storage medium as claimed in claim 3, wherein the system parameter blocks include master boot record (MBR), basic input/output system (BIOS) parameter block (BPB), file allocation table (FAT), and root directory.

6. The method for expediting reading and writing on a non-volatile storage medium as claimed in claim 5, wherein the step of correcting the parameters of the system parameter blocks is to correct the parameters of the master boot record (MBR) and BIOS parameter block (BPB).

7. The method for expediting reading and writing on a non-volatile storage medium as claimed in claim 1, wherein the work of adjusting the size, location, and allocation unit (cluster) of each system parameter block is carried out by labor manipulation.

8. The method for expediting reading and writing on a non-volatile storage medium as claimed in claim 1, wherein the smallest unit of a file is a cluster.
